(19) United States
(12) Patent Application Publication
(10) Pub. No.: US 2007/0081469 A1
(43) Pub. Date: Apr. 12, 2007

(54) System and methods for wireless fidelity (WIFI) venue utilization monitoring and management

(75) Inventors: Bob Tracy, Dublin, CA (US); John Monday, San Antonio, TX (US); Rich Mori, San Antonio, TX (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/247,439

(22) Filed: Oct. 11, 2005

(51) Int. Cl. H04J 1/16

(52) U.S. Cl. 370/252

(57) ABSTRACT

The present invention provides a method of monitoring and managing utilization levels of a wireless fidelity (WIFI) network. An inventory is obtained relating to the WIFI venues, including information on IP (Internet Protocol) and SNMP (Simple Network Monitoring Protocol) addresses of WIFI venues, associated circuitry, network equipment, capacity bandwidth, etc. Network Monitoring Devices (NMDs) having data transfer rates between and the network WIFI venues are polled. Polling is typically performed over a predetermined time period (such as the previous 24 hours) and the peak traffic levels over one or more network elements is determined. Utilization levels are determined by comparing the peak traffic levels to bandwidths at the venue. Utilization levels are also tracked over a period of time. Deviations in utilization levels that indicate network congestion may be tracked in order to determine the cause of a network congestion.

### BACKGROUND OF THE INVENTION

1. Field of the Invention

The present invention relates generally to the field of communications networks and more particular to a system and methods of monitoring and managing utilization levels at a wireless network venues.

2. Description of the Related Art

A very large number (hundreds to thousands in large cities) of wireless communications outlets or locations, commonly known as Wireless Fidelity (WIFI) venues or “hot spots” are currently available allowing access to Internet services. A hotspot is usually a WIFI access point or area where customers using wireless technology devices, such as portable computers, personal display apparatus (PDA), cellular phones using Voice over Internet Protocol (VoIP), and the like can connect to the Internet. Hotspots are often found in such places as restaurants, train stations, airports, cafes, libraries, and other public places. Such venues for wireless communications and access points utilize equipment and services which are usually bundled and provided by service providers, such as the assignee of this application and other telecommunication companies. Each hot spot has a capacity or bandwidth i.e. the maximum amount of data that can be transferred between the hot spot the network. The number of customers at a given hotspot can vary on an hourly basis, with certain time periods having or defining the maximum load for hotspot. Such loads can result in large daily spikes in the network use from the hotspots. It is desirable for the service providers and the equipment providers to anticipate or determine when and the extent to which equipment located at the hotspot and/or in the network should be augmented to provide an effective (efficient and cost effective) service to the customers, instead of reacting to customer complaints of shortages or inadequate services. Thus, it is desirable to have a system and methods for automatically monitoring and managing the many WIFI venues in a network and taking corrective actions.

Current methods to monitor the large numbers of WIFI venues for possible congestion and service impairment are primarily reactive in nature rather than proactive. Simple Network Management Protocol (SNMP) is a widely used protocol for monitoring the health and welfare of network equipment (e.g. routers). Current monitoring methods utilize manually entering individual SNMP commands to individual WIFI venues, accumulating the results, and determining possible congested WIFI venues. Such manual methods are inefficient and cumbersome and thus impractical to manage the very large number of such venues in any network. Therefore, this practice is not widely implemented in large WIFI networks. Also, customer outages and trouble tickets are used at present to identify circuit and equipment performance, again without providing proactive capabilities. The present invention addresses the above noted needs and provides a system and methods for tracking utilization levels for the WIFI venues and to proactively manage the network circuit and/or equipment needs, as necessary, prior to (in many instances) the occurrence of congestions and service impairment.

### SUMMARY OF THE INVENTION

The present invention, in one aspect, provides a method of monitoring utilization levels of a wireless fidelity (WIFI) network. The method includes obtaining an inventory relating to a WIFI venue. An exemplary inventory for the selected WIFI avenue may provide information relating to the bandwidth, IP (Internet Protocol), SNMP (Simple Network Monitoring Protocol) addresses of the WIFI venue, associated circuitry, network links, network equipment, and any other suitable or desired elements. The method further includes polling a Network Monitoring Device (NMD) associated with the WIFI venue. The polling may provide information about the data transfer rates between the WIFI venue and the network for selected time periods. Polling may be performed for a predetermined time period (such as the previous 24 hours). The method further includes determining a peak traffic level between the WIFI venue and the network over one or more network elements. In one aspect, the utilization level of the WIFI avenue is determined by comparing the peak traffic level and the bandwidth at the venue.

In another aspect of the method, equipment may be augmented when the determined utilization level exceeds a threshold set by the service provider. Additionally, monitoring utilization levels further may include tracking summarized utility levels for various WIFI avenues over a period of time. Deviations in the utilization levels that indicate network congestion are noted or logged. These deviations may be tracked in order to determine the cause of network congestion.

The invention also provides a computer program that when executed by a computer or processor executes the methods of the invention. The invention also provides a computer system associated with the network that accesses one or more database, to obtain information about the capacities and peak data transfer rates for various WIFI avenues and provides reports to take corrective actions to avoid congestion or service impairments.

Examples of certain features of the invention have been summarized here, rather broadly, in order that the detailed description that follows may be better understood and in order that the contributions they represent to the art may be appreciated. There are, of course, additional features of the invention that will be described hereinafter and which will form the subject of the claims appended hereto.

### BRIEF DESCRIPTION OF THE DRAWINGS

For detailed understanding of the present invention, references should be made to the following detailed description of an exemplary embodiment, taken in conjunction with the accompanying drawings, in which like elements have been given like numerals.

FIG. 1 illustrates an exemplary WIFI network connection or system;

FIGS. 2A-B illustrates an exemplary WIFI Utilization Report provided according to one aspect of the present invention;

FIG. 3 illustrates an exemplary report obtainable by running a Cricket application;

FIG. 4A illustrates an exemplary graph of the daily percentage of active venues being monitored;

FIG. 4B illustrates an exemplary historical graph of utilization levels;

FIG. 5 illustrates an exemplary graph detailing historical trends of utilization levels;

FIGS. 6A-B illustrates an exemplary charts of events and their effects according to various categories;

FIG. 7 illustrates an exemplary high-level flowchart for producing a utilization report of a WIFI network connection; and

FIG. 8 illustrates an exemplary flowchart for implementing the present invention within an exemplary organization.

### DETAILED DESCRIPTION OF THE INVENTION

In view of the above, the present invention through one or more of its various aspects and/or embodiments is presented to provide one or more advantages, such as those noted below.

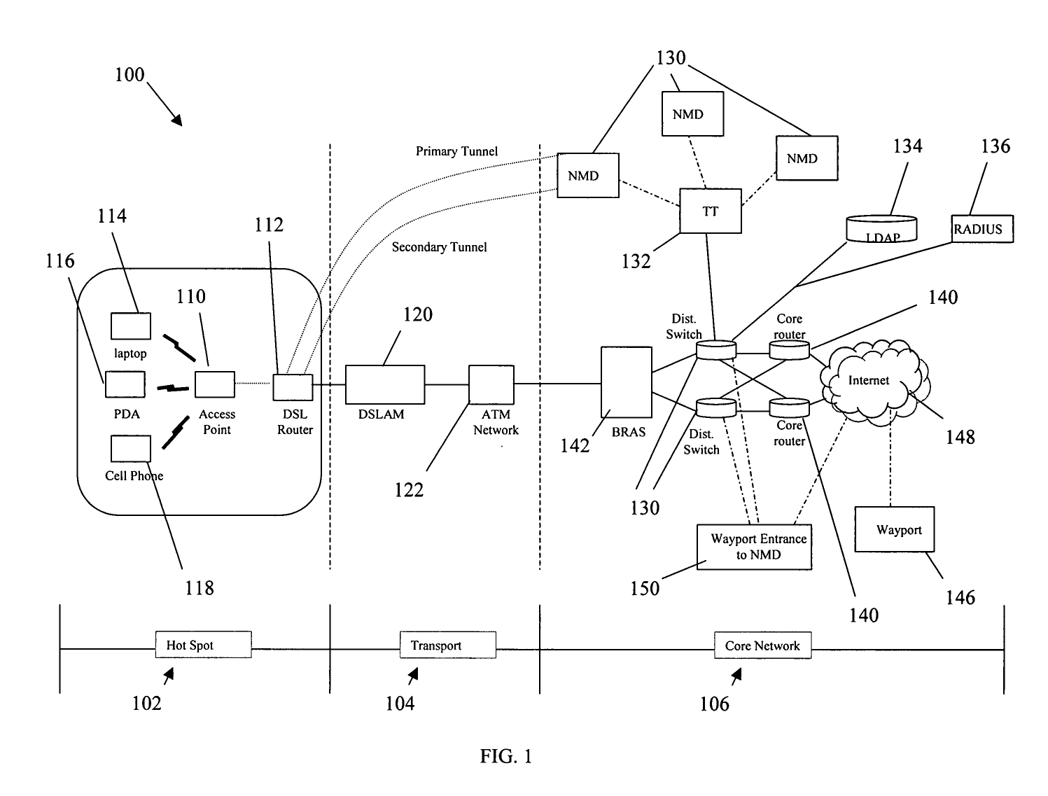

FIG. 1 illustrates an exemplary WIFI network connection or system 100. The system 100 includes a number of avenues or Hotspots, such as an exemplary hotspot 102, that are connected or coupled to a core network 106 via a variety of network devices located in a transport network 104. The exemplary hotspot 102 may include devices that enable customers to connect their devices to the network, including the Internet. The venue 102 may include devices, such as a router 112 that may be a DSL (Digital Subscriber Line) router to provide connectivity to an outside network over communication links, such as existing copper wires for telephone services or optical fibers. An Access Point (AP) device 110, connected to the router 112, performs wireless communication with the various types of customer equipment, including laptop computers 114, PDA devices 116, and cell phone 118 configured for VoIP services. The router is a two way communication device between the WIFI venue and the remaining network.

An exemplary transport section 104 of the network connection 100 may include a number of DSLAMs (Digital Subscriber Loop Access Multiplexer) 120 and an Asynchronous Transfer Mode (ATM) network 122. A DSLAM is a device that links many customer DSL connections to a single high-speed line. The DSLAM 120 transfers data to and from the ATM network 122. The ATM network usually transfers data in cells of a predetermined fixed size. Standard connection links, such as copper wires or a fiber optic cabling, are made between the DSLAM and the ATM network.

One or more Broadband Remote Access Servers (BRAS) 142, located at the core network 106, route traffic (data) between the DSLAM 120 and the core network 106. The BRAS 142 aggregates user sessions from the DSLAMs. Policy management issues and IP Quality of Service (QoS) are often addressed by an operator accessing the BRAS. The core network may include the BRAS 142, a series of Distribution Switches 138, and Core Routers 140 to provide connectivity to the Internet 148. The core routers 140 also transmit data between other routers in the network. An LDAP (Lightweight Directory Access Protocol) 134 and RADIUS (Remote Access Dial-In User Service) 136 servers provide security and directory features to the core network 106. RADIUS 136 is a distributed security system that secures remote access to networks and network services against unauthorized access. LDAP 134 is a directory information model and a protocol accessing the information.

The system 100 further includes one or more Network Monitoring Devices, such as Network Monitoring Device (NMD) 130, that may be connected to a tunnel terminator 132. The Tunnel terminator 132 provides a network element for delivering data to the appropriate NMD 130. An NMD is a device that performs various diagnostic tests as well as obtains data related to the network connectivity from various network elements. A single NMD can monitor multiple Access Points 110. Data that is extracted from the DSL router 112 at the venue is transferred to the tunnel terminator 132 and on to the appropriate NMD 130 using a suitable tunneling mechanism, such as Generic Routing Encapsulation (GRE), Layer 2 Tunneling Protocol, or another suitable tunneling protocol. Maintenance data can be transferred to various entities, including an operation center for daily network maintenance 146 through a network 150. Thus, in the exemplary system 100, data transmitted from each venue may be polled or obtained for any time period through the NMDs to determine the peak usage for such venues. The inventory and particularly the capacity for each venue may be compared with the peak usage to determine the usage level of the WIFI avenues and to take corrective actions, if any, including whether and when to augment equipment at any given venue or in the network as described in more detail below. The system may automatically generate reports for information and/or for taking corrective actions based on business criteria set or predefined for any given venue or user.

Still referring to FIG. 1, one aspect of the present invention provides a WIFI Utilization Report for the WIFI venue. The WIFI Utilization Report may be in the form of an Excel spreadsheet (that may be ˜50Mb each calendar month). The WIFI Utilization Report may include an NMD (Network Monitoring Device) worksheet, a CKTS (circuits) worksheet, and a dated worksheet that includes information about the venues obtained on a given date. The NMD worksheet may be a worksheet that includes information about the venues and the equipment at each such venue. A circuit worksheet may be a worksheet that may include circuitry information relating to the venues.

Data used in the WIFI Utilization Report may be obtained from a first input source related to network element specifications and from a second input source related to traffic data at venues. The first input source may be extracted from a WIFI Tool Portal Web site. The WIFI Tool Portal typically includes a database of active WIFI venues, referred to herein sometimes as the WIFI venue inventory, and a database on active WIFI circuitry. Table 1 illustrates an exemplary extraction from the WIFI venue inventory. These data bases may be part of the same data base.

TABLE 1

| Extracts Jan. 3, 2005 | |
|---|---|
| Green | 4 |
| Active | 2537 |
| Red | 0 |
| Discontinued | 0 |
| Hold | 256 |
| disconnected | 1 |
| Pending Disconnect | 0 |
| unknown | 1028 |
| Total | 3826 |
| Green + Active + Red | 2541 |
| Discon + hold | 257 |
| number monitored | 729 |
| % monitored | 28.7% |
| % peaking over 100% | 0.31% |

The exemplary Table 1 shows a listing of different venue categories in the left column, with the number of venues falling into the listed category in the right column. In the example of Table 1, the total number of venues is 3826, and the total number of venues that are not discontinued or on hold is 2541. The number of venues being monitored is 729. Thus, in this example, 28.7% of the venues are monitored. Data for the NMDs worksheet is extracted from the WIFI venue inventory database of the WIFI Tool Portal and the data for the CKTS (circuits worksheet) is extracted from the database on active WIFI circuitry of the WIFI Tool Portal. Furthermore, data may be extracted according to specifications of the operator. For instance, information may be extracted specific to, or excluding, a given client. Multiple extractions may be combined into one NMDs worksheet. WIFI venue name and expected SNMP (Simple Network Monitoring Protocol) hostname address are typically used as field names in the NMDs worksheet. The circuit inventory may be combined into a single “ckts” worksheet. The WIFI venue name and the circuit speed are typically used as fields for the “ckts” worksheet.

The second input source is located at one or more NMDs and relates to transit traffic bandwidth. The information can be compiled using a Cricket application. The Cricket monitoring system is an application for collecting and polling responses from NMDs. A typical polling command could be SNMPGET that uses a GET request to query for information on a network entity. Values such as peak bandwidth (or average bandwidth) and percent utilization (that may be calculated from the peak or average values) can be identified and isolated according to various desired categories, such as the WIFI customer, the WIFI facility (including Ethernet, OC3, DS3, and DS1 facilities), the Access Point, the NMD, etc. The Cricket application polling the NMDs is able to sort these match parameters according to categories.

Polling may be executed automatically using any know method, such as a CRON feature of a server running nightly scripts to execute the Cricket application. CRON is a UNIX command for scheduling jobs to be executed at a time in the future and can be used to schedule a job to be executed periodically. Polling commands from Cricket (e.g., SNMPGET) generates a response from the one or more NMDs about the peak count of octets that transited the NMD during a predetermined peak-traffic time period, which may be a 15-minute period during the previous 24 hours.

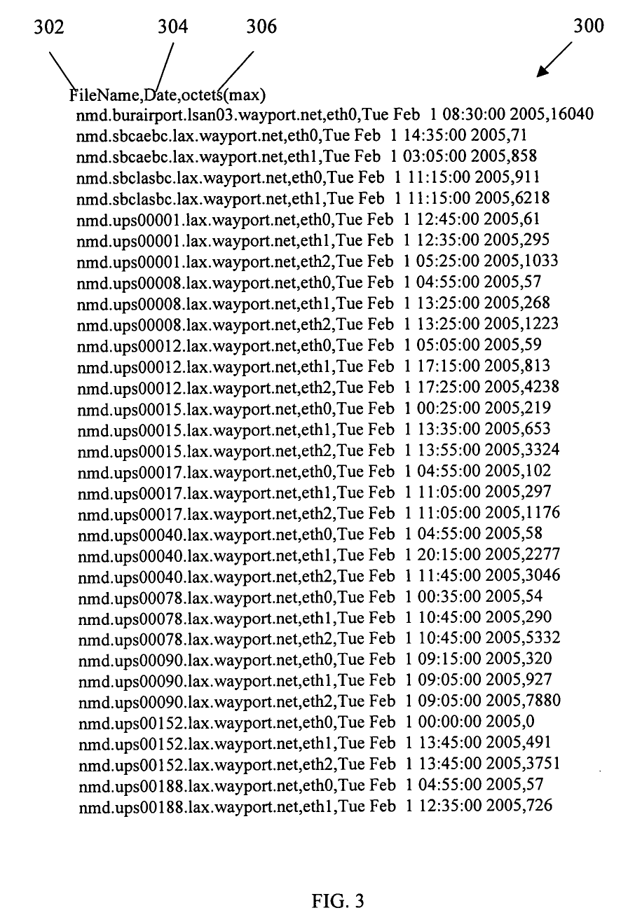

FIG. 3 illustrates an exemplary report obtainable by running a Cricket application. Each line of the report 300 indicates a Filename 302, a Date 304 indicating a 15-minute period of peak traffic, and an octet (i.e., an 8-bit-byte) reading 306 indicating the maximum number of octets recorded in the 15-minute period.

Response to the SNMPGET polling commands is generally converted from octets into kilobits per second (Kbps) at the WIFI venue using Eq. (1):
Kbps=(Octets*8)/1024. Eq. (1)
The value of actual traffic returned from Eq. (1) represents a value for the actual traffic at the venue. This value is divided by the circuit bandwidth to calculate a percent utilization (Eq. (2)) of the circuit attached to the NMD being monitored:
% utilization=(actual_traffic/available_bandwidth) Eq. (2)
Knowledge of the percentage utilization enables an operator to proactively isolate potential congestion points at the customer locations in the WIFI network. The value of circuit bandwidth is extractable from the WIFI Tool Portal data bases or a tool for the monitoring of wireless network connections and tracking individual network usage. Data obtained using the Cricket application is fed into a dated worksheet labeled according to the extraction date of the data (i.e. 1-3-05) and integrated into the WIFI Utilization report. Any other set of rules may be utilized for determining the utilization levels.

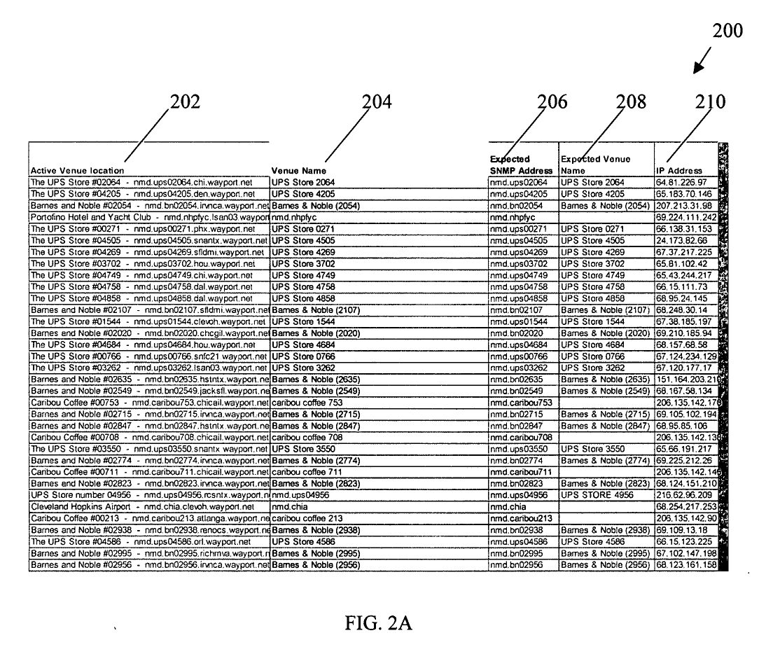

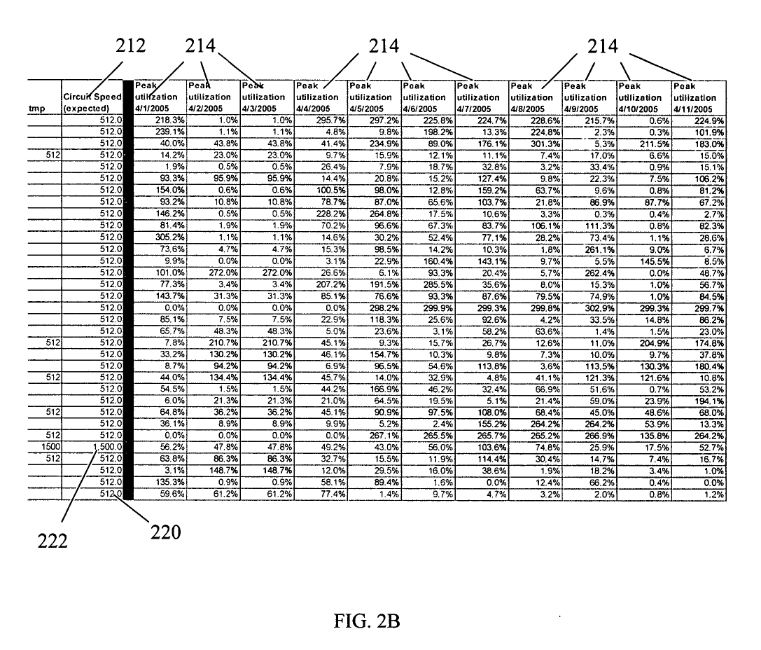

FIGS. 2A and 2B illustrate an exemplary WIFI Utilization Report 200 in one aspect of the present invention. FIGS. 2A and 2B displays a sample output of data related to active venue percentages. The worksheet includes fields for “Active Venue location” 202, Venue Name” 204, “Expected SNMP Address” 206, “Expected Venue Name” 208, “IP Address” 210, “Circuit Speed (Expected)” 212, as well as percentages for daily “Peak utilization” 214.

The circuit speed 212 is the expected speed entered into the WIFI Tool Portal. When no circuit speed is entered in the “ckts” worksheet for the circuit speed column, 128 Kbps in the upstream direction and 384 Kbps in the downstream direction is the default value of the bandwidth. Combining these two bandwidths gives a total of 512 Kbps capacity (220). Actual capacity could differ from this assumed and minimum rate. Some typical transport rates, are 1.1 million bits per second (mbps) and 1.5 mbps (222). Extract dates, such as shown in 214, indicate the date at which inventories are obtained from the SBC WIFI Tool Portal web site. An actual speed is calculated by summing of NMD octets at the several channels at a venue (i.e., ethernet 0, 1, and 2). Utilization is calculated when both the actual speed (from Cricket) and the expected speed (from the WIFI Tool Portal) are known. The utilization report relates the peak 15-minute measurement of traffic in the previous 24-hour period. Utilization levels are determined with respect to a single channel capacity and thus can exceed 100% when a venue contains many channels.

Table 2 illustrates an exemplary summary report of daily utilization levels. Reports are usually compiled daily and include data on the number of active venues, the number of venues monitored, the percentage of monitored venues, the number of venues experiencing a utilization over a predetermined threshold, for example 75% of circuit bandwidth, and the totaled percentage points of the sites which exceeds the 75% threshold. In the example of Table 1, the threshold for investigating augmenting facilities and equipment is 75% utilization. However, a different percentage or a criterion may be selected which more suitably represents a congested level. For example, on 4/1/2005, 3513 venues were active and 2239 venues were monitored. This yields a 63.7% monitoring rate. There were 31 venues experiencing utilization levels exceeding the 75% threshold. The totaled percentage points of sites exceeding the 75% utilization level totaled 4194.3 percentage points.

TABLE 2

| | F 4/1/2005 | Apr. 2, 2005 | Apr. 3, 2005 |
|---|---|---|---|
| # venue active (bom) | 3513 | 3513 | 3513 |
| # venue monitored | 2239 | 2223 | 2223 |
| % monitored | 63.7% | 63.3% | 63.3% |
| # venue over 75% | 31 | 24 | 24 |
| % points over 75% | 4194.3% | 3056.3% | 3056.3% |

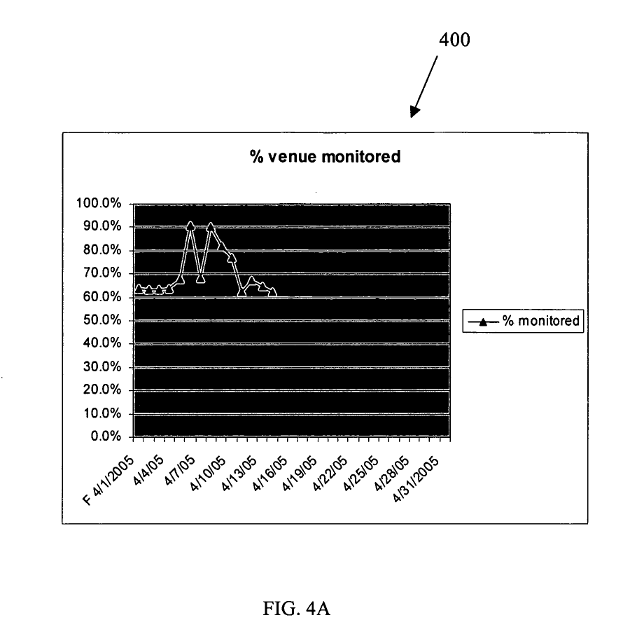

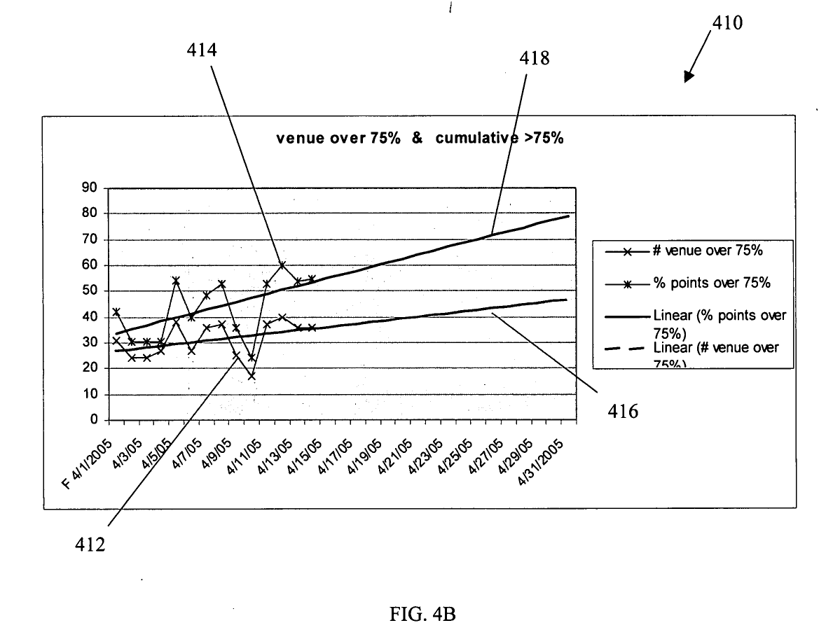

FIG. 4A illustrates an exemplary graph 400 of the percentage of active venues being monitored each day. Time is represented in days along the x-axis, and percentage is represented along the y-axis. FIG. 4B illustrates a historical graph of utilization levels. Dataset 412 represents the number of venues exceeding 75% utilization. Dataset 414 represents the totaled percentage points of the venues exceeding the 75% threshold. Line 416 is a linear fit of the number of the totaled percentage points for venues exceeding 75% utilization (412). Line 418 is a linear fit of the percentage points of the venues exceeding the 75% threshold (414).

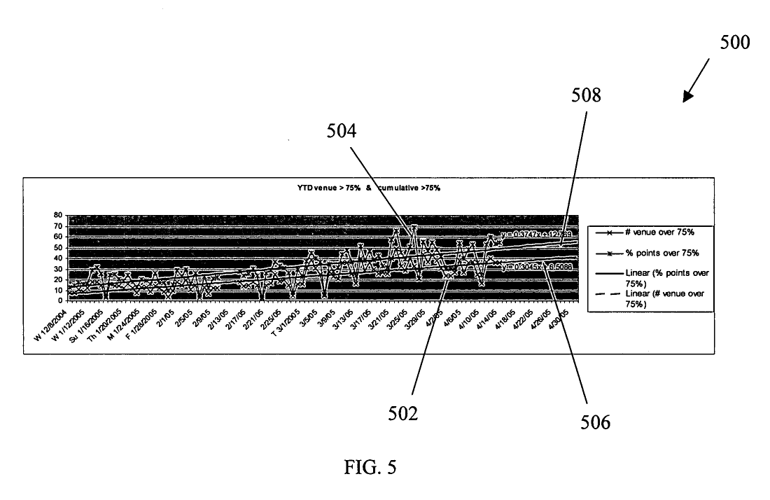

FIG. 5 illustrates an exemplary graph 500 detailing historical trends of utilization levels. Dataset 502 indicates a daily tally of the number of venues over 75%. The x-axis represents time in days, and the y-axis represent percentages. Dataset 504 indicates a daily tally of the percentage points over 75%. Line 506 is a linear fit of the number of venues exceeding 75% utilization. Line 508 is a linear fit of the totaled percentage points of venues exceeding the 75% threshold.

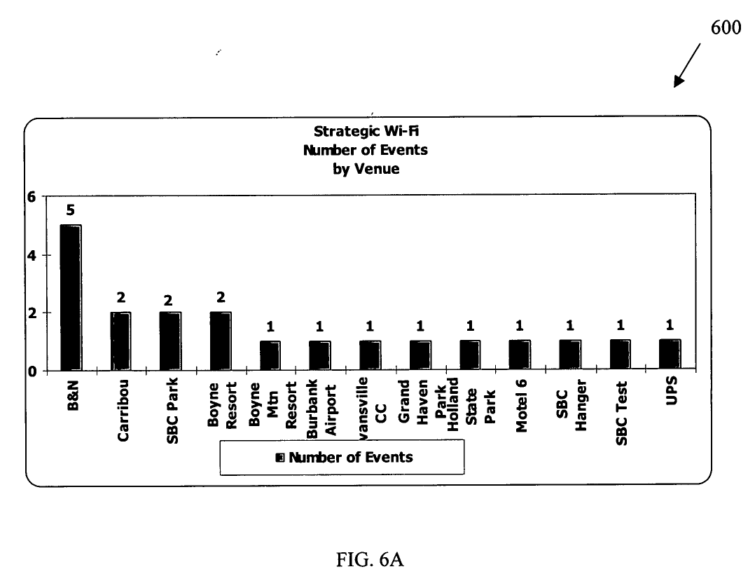

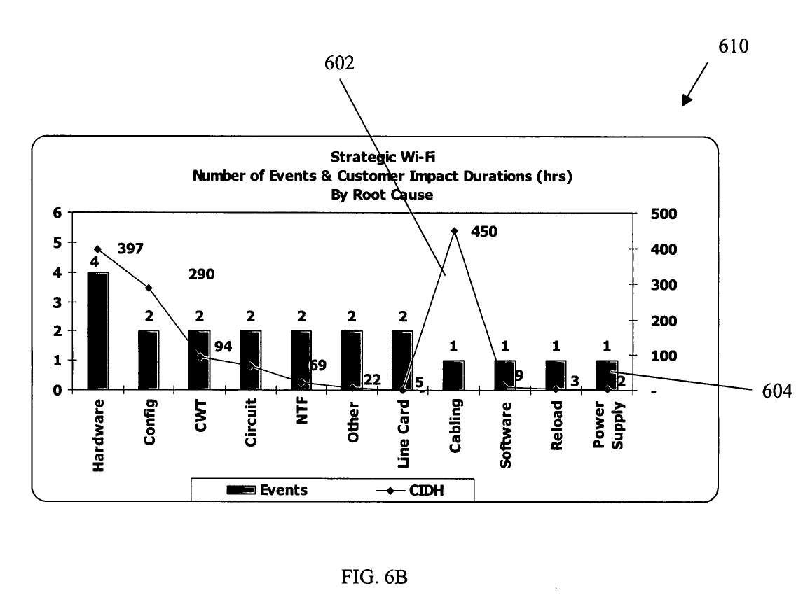

FIG. 6A illustrates an exemplary chart 600 of network events occurring at several venues as categorized by clients experiencing the network events. The clients are listed along the x-axis. The y-axis indicates the number of events occurring at each client. FIG. 6B illustrates a chart 610 of network events categorized by the network category at which the event occurred. FIG. 6B also plots the resultant customer impact in customer impact duration (hrs). A list of root causes (i.e., hardware, configuration, cabling, line card, etc.) for a network event is shown along the x-axis. The y-axis along the left hand side of the chart indicates the number of network events attributable to the root cause listing along the x-axis. The number of events per root causes is displayed via histogram 604. The y-axis along the right hand side of the chart indicates the duration of the network event in terms of costumer impact duration (in hours) and pertains to the line 602 of the chart.

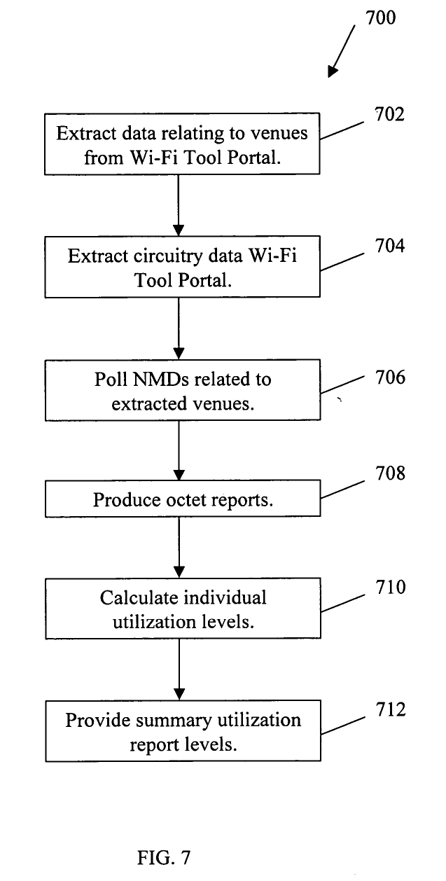

FIG. 7 illustrates an exemplary flowchart 700 for producing a utilization report of a WIFI network connection. In Box 702, data is extract from the WIFI Tool Portal website related to the WIFI venues. This data includes location information such as IP address and SNMP hostname address. In Box 704, circuitry data is extracted from the WIFI Tool Portal website. In Box 706, an application such as Cricket polls NMDs related to the venues obtained in Box 702. This data is generally stored in a an ASCII text file (see FIG. 3) as is performed in Box 708. Calculations are performed on the octets to obtain values for actual traffic (using Eq.(1)) and values for percentage utilization (using Eq.(2)). These calculations are performed in Box 710. The circuit utilization is tracked on a daily basis to indicate a possible congestion problem that requires further research and possible equipment or facility augmentation. Summary reports, such as shown in FIGS. 4A, 4B, and 5, are produced in Box 712 and use the utilization levels calculated in Box 710.

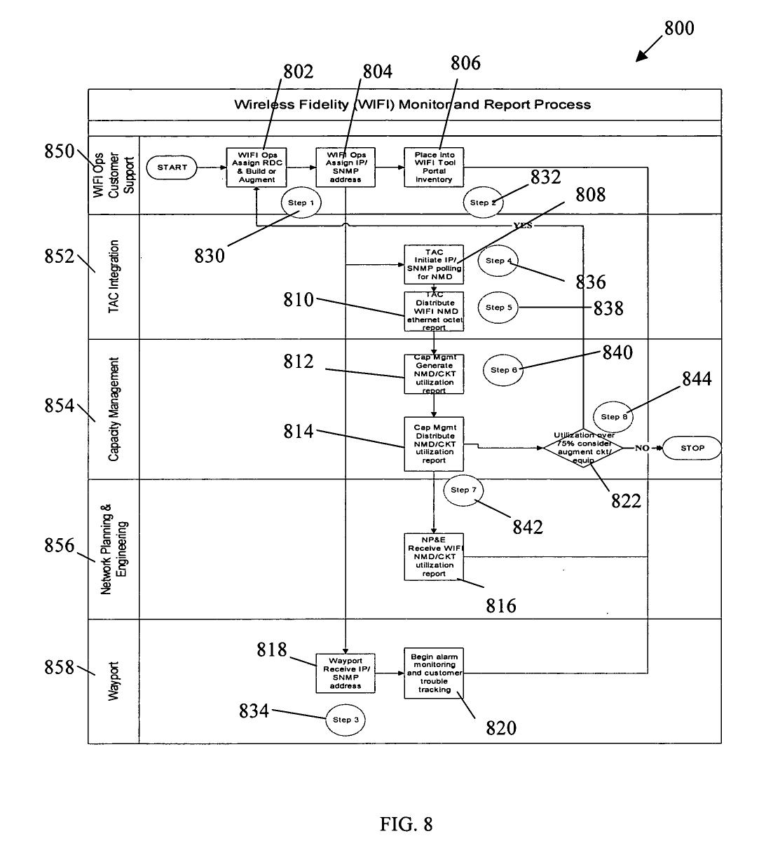

FIG. 8 illustrates an exemplary flowchart 800 for implementing one aspect of the invention within an exemplary organization. The exemplary organization involves interacting groups, including a WIFI Customer Support group 850, a Technical Access Center (TAC) Integration group 852, a Capacity Management group 854, a Network Planning & Engineering (NP&E) group 856, and a Wayport group 858. The WIFI Customer Support 850 is responsible for initial ordering and coordinating of equipment for customer service 802, assigning IP (Internet Protocol) and SNMP address 804, and maintaining inventories of active venues, circuits, circuit speed, bandwidth, and equipment, etc. at a WIFI Tool Portal 806 web site. When inadequate capacity is identified, the WIFI Customer Support group implements an augment to the WIFI equipment and facilities. In Box 830, The WIFI Customer Support group assigns an SNMP hostname and IP address for access to customer equipment, including new circuits and the circuit augments.

In Box 832, The WIFI Customer Support group distributes the IP and SNMP address to the TAC Integration group 852 and to the Wayport group 858 for monitoring. The TAC Integration group is responsible for the daily maintenance and monitoring of WIFI service at a customer level. WIFI equipment is polled based upon a hostname address obtained from WIFI Customer Support. The Wayport group collects and responds to trouble tickets (see FIGS. 6) and restores equipment. In Box 834, the Wayport group receives the IP and SNMP address 818 and begins monitoring for equipment alarms and collecting customer trouble reports 820.

In Box 836, the TAC Integration group polls NMDs and collects statistics of octets transiting WIFI NMDs (as specified by the IP and SNMP supplied by the Wifi Customer Support group). This collected information is provided to the Capacity Management group (Box 838).

Capacity Management is responsible for reviewing daily utilization summaries 812 (see, for example, FIGS. 2A and 2B) provided by TAC Integration. Capacity Management also provides a monthly summary of WIFI customer utilization 814 (see, for example, FIGS. 4A, 4B, and 5). In Box 840, Capacity Management generates a WIFI Utilization report using the Peak Performance report and the inventory information from the WIFI Tool Portal.

In Box 842, Capacity Management distributes the Utilization report summary and charts to the NP&E group. The NP&E group communicates WIFI utilization indices and service levels to management. In Box 844, Capacity Management uses the WIFI Utilization report to identify possible congestion in the individual customer circuits and equipment. If applicable, Capacity Management refers possible congestion problems to WIFI Ops Customer Support for research to augment circuits and equipment, thereby triggering proactive augments of WIFI architecture.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

What is claimed is:

1. A computer readable medium containing a set of instructions operative to cause a computer to execute a method, the method comprising:
polling a network monitoring device that at least periodically receives data transfer information between at least one WIFI venue and a communications network;
determining a peak data transfer level between the at least one venue and the network from information received by polling the network monitoring device;
receiving a transfer capacity level relating for the at least one WIFI venue; and
determining from the received capacity level and the determined peak data transfer level a utilization level of the at least one venue.

2. The computer readable medium of claim 1 wherein the method further comprises receiving an inventory for the at least one venue that includes information about at least one data transfer device at the at least one venue.

3. The computer readable medium of claim 1 wherein the peak data transfer level is a peak traffic experienced during a selected time period in a 24-hour period.

4. The computer readable medium of claim 1 wherein determining the utilization level further comprises comparing the peak data transfer level to a bandwidth capacity at the at least one venue.

5. The computer readable medium of claim 1 wherein the method further comprises tracking summarized utilization levels over a period of time.

6. The computer readable medium of claim 1 wherein the method further comprises categorizing deviations in utilization levels that indicate network congestion.

7. The computer readable medium of claim 1 wherein the pulling further comprises receiving data transfer information for a plurality of venues and determining utilization level for each venue in the plurality of venues.

8. A method of determining a utilization level of at least one Wireless Fidelity (WIFI) venue in a data communication network comprising:
receiving data transfer information relating to the at least one venue;
determining a peak data transfer level between the at least one venue and the network from the received data transfer information;
receiving a data transfer capacity level relating to the at least one venue; and
determining from the received capacity level and the determined peak data transfer level the utilization level of the at least one venue.

9. The method of claim 8 further comprising obtaining an inventory for the at least one venue that includes information about a data transfer device at the at least one venue.

10. The method of claim 8 wherein the peak data transfer level is the peak traffic experienced during a selected time period in a 24-hour period.

11. The method of claim 8, wherein the capacity level is a bandwidth associated with the at least one venue.

12. The method of claim 8 wherein the at least one venue includes a plurality of venues and the method further comprising tracking summarized utilization levels for each venue in the plurality of venues over a period of time.

13. The method of claim 12 further comprising categorizing deviations in the utilization levels that indicate network congestion.

14. The method of claim 8 wherein the at least one venue includes a plurality of venues, the method further comprising communicating data transfer information from each venue to a common network monitoring device, and polling the network monitoring device over the Internet to receive data transfer information for each said venue.

15. The method of claim 2 further comprising augmenting the at least one data transfer device at the at least one venue if the determined utilization level of the at least one venue exceeds a threshold.

16. A system comprising:
a server having a processor;
a data base structure accessible to the processor that contains data transfer rates between a plurality of WIFI venues and a communication network;
a data base structure accessible to the processor that includes an inventory file for each venue in the plurality of venues, each said inventory file including a data transfer capacity between each venue in the plurality of venues and the communication network;
a computer readable medium accessible to the processor; and
a computer program embedded in the computer readable medium, the computer program comprising:
instructions to receive data transfer rates between the venues in the plurality of venues and the communication network;
instructions to receive capacity level for each venue in the plurality of venues; and
determining a utilization from the data transfer rates and the capacity for each venue in the plurality of venues.

17. The system of claim 16 wherein the processor provides a utilization report for the venues.

18. The system of claim 17 wherein the processor system compares a peak data transfer rate for each venue and a threshold.

19. The system of claim 16 wherein the processor makes available the determined utilization level for each of the venues over the internet.

20. The system of claim 16 wherein the processor compares the data transfer capacity with a peak data transfer between each venue and the network to determine the utilization for each venue.
